(19) United States
(12) Patent Application Publication
(10) Pub. No.: US 2026/0103259 A1
(43) Pub. Date: Apr. 16, 2026

(54) SHIFTING ARRANGEMENT FOR A BICYCLE TRANSMISSION, TRANSMISSION UNIT AND SHIFTING METHOD

(71) Applicant: Pinion GmbH, Denkendorf (DE)

(72) Inventors: Michael Schmitz, Denkendorf (DE); Leonhard Manss, Denkendorf (DE)

(21) Appl. No.: 19/418,931

(22) Filed: Dec. 13, 2025

Related U.S. Application Data
(63) Continuation of application No. PCT/EP2024/066068, filed on Jun. 11, 2024.

(30) Foreign Application Priority Data
Jun. 16, 2023 (DE) 10 2023 115 807.4

(51) Int. Cl. B62M 11/06; B62M 11/14

(52) U.S. Cl. CPC B62M 11/08; B62M 11/145

(57) ABSTRACT

A shifting arrangement for a vehicle transmission of a vehicle that can be driven by at least one of muscle power and motor power. The shifting arrangement comprises a transmission shaft assembly, on which a plurality of idler gears are rotatably mounted, which can be connected to the transmission shaft assembly via respective shifting devices. The shifting devices can be actuated by means of a camshaft assembly, which comprises a first camshaft. The first camshaft and a second camshaft of the camshaft assembly are coupled to one another via a reversing transmission in such a way that a rotation of one of the camshafts in a first rotation direction leads to a rotation of the other camshaft in a second rotation direction, which is opposite to the first rotation direction.

### CROSS-REFERENCE TO RELATED APPLICATIONS

This is a Continuation application of International patent application PCT/EP2024/066068, filed Jun. 11, 2024, which claims the priority of German patent application DE 10 2023 115 807.4 filed Jun. 16, 2023. Both application PCT/EP2024/066068 and DE 10 2023 115 807.4 are hereby incorporated by reference in their entireties.

### FIELD

The present disclosure relates to a shifting arrangement for a vehicle transmission, in particular for a transmission of a vehicle that can be driven by muscle power and/or by motor power, comprising a transmission shaft assembly, on which a plurality of idler gears are rotatably mounted, which can be connected to the transmission shaft assembly via respective shifting devices, wherein the shifting devices can be actuated by means of a camshaft assembly, which comprises a first camshaft.

The present disclosure therefore generally relates to the field of vehicles driven by muscle power, in particular bicycles. However, the disclosure also relates to vehicle transmissions such as those that can be used in vehicles that can be driven by muscle power and motor power, i.e., in such e-bikes where an electric motor provides additional drive power. However, the disclosure is also applicable to other types of vehicles that can be driven by motor power, for example e-bikes without pedals. In general, shifting arrangements of the described type are also applicable in other fields which include drivetrains with spur gear transmissions that can be shifted via camshafts.

### BACKGROUND

In the field of bicycles and e-bikes, a distinction is essentially made between three types of shifting systems. The first type of shifting system is derailleur gears, as have been known for many years. The second type of shifting system is a so-called hub gear, as is often integrated in the hub of a rear wheel of a bicycle. This is usually realized as a planetary transmission.

The third type of shifting system is so-called bicycle transmissions, which are mounted in the area of a bottom bracket. Such a bicycle transmission, which is realized in a spur gear design, is known, for example, from document EP 2 379 402 B2. This document relates to a shifting device for a transmission unit, with a first shaft on which a plurality of idler gears are mounted, a corresponding number of gear wheels which are mounted on at least a second shaft, wherein the idler gears can be connected to the first shaft by means of respective shifting devices and wherein the first shaft is designed as a hollow shaft which has one or two coaxially internal camshafts (referred to therein as shifting pins). The camshaft(s) is or are connected to drive means which are designed to rotate the camshaft(s) in order to actuate the shifting devices. The drive means include a speed-superposition transmission, which is designed as a planetary transmission. The shifting devices are designed as switchable freewheels. Actuating portions are formed on the camshaft, by means of which the freewheels can be actuated. The actuating portions are arranged on the camshafts in such a way that the freewheels of two consecutive gear stages can be actuated simultaneously.

If the transmission unit has two series-connected sub-transmissions in the manner of a range-type transmission, two camshafts are provided which can be actuated independently of one another.

The shifting device described in document EP 2 379 402 B2 enables very short shifting times.

From document WO 2019/166563 A1, a further transmission unit is known, in which a shifting arrangement is designed such that shifts can be performed under load.

The requirements for such shifting arrangements are significantly increased for the application in an e-bike compared to the application in conventional bicycles. Due to the sometimes significantly higher torques that are transmitted via the transmission unit and consequently also partially via the shifting arrangement, high requirements arise in particular with regard to the coordination of the timing sequences (the “timing”) during shifting operations.

### SUMMARY

Against this background, it is an object of the disclosure to provide an improved shifting arrangement, an improved transmission unit, and improved shifting methods.

The above object may be solved by a shifting arrangement for a vehicle transmission, in particular for a transmission of a vehicle that can be driven by muscle power and/or by motor power, comprising a transmission shaft assembly, on which a plurality of idler gears are rotatably mounted, which can be connected to the transmission shaft assembly via respective shifting devices, wherein the shifting devices can be actuated by means of a camshaft assembly, which comprises a first camshaft, wherein the first camshaft and a second camshaft of the camshaft assembly are coupled to one another via a reversing transmission, in such a way that a rotation of one of the camshafts in a first rotation direction leads to a rotation of the other camshaft in a second rotation direction, which is opposite to the first rotation direction.

Furthermore, the above object may be solved by a transmission unit with such a shifting arrangement and by a method for performing gear shifts by means of such a shifting arrangement, comprising the step of rotating the camshaft assembly by a shift rotation angle to disengage a source gear stage and to engage a target gear stage.

The shifting arrangement according to the disclosure is particularly usable in such transmission units that have two shiftable sub-transmissions, wherein idler gears of the first sub-transmission and of the second sub-transmission are preferably mounted on a transmission shaft assembly. This results in a situation where the shifting devices, viewed in the circumferential direction, must be oppositely oriented in the second sub-transmission to the shifting devices of the first sub-transmission (see, for example, FIG. 11 of the aforementioned European patent EP 2 379 402 B2).

By the measure of coupling the first camshaft and the second camshaft to one another via a reversing transmission, the rotation directions of the camshafts are consequently opposite. As a result, the same kinematics can be produced between the two camshafts and the assigned shifting devices. In other words, the shifting devices can be uniformly oriented when viewed in the circumferential direction. This allows the same, good shiftability under load to be realized in both sub-transmissions.

It is nevertheless possible to drive only one of the two camshafts to perform shifting operations. Consequently, it is not necessary to control the camshafts independently of one another, which would mean an increased mechanical and control-related effort.

Preferably, neither of the two camshafts is designed to be axially displaceable. The axial positions of the camshafts are rather preferably fixed.

Preferably, the camshaft assembly is actuated by means of a shift actuator, in particular in the form of an electric motor, preferably by coupling the shift actuator to only one of the first camshaft and the second camshaft.

The object is thus completely solved.

It is particularly advantageous if the transmission shaft assembly is designed such that a drive force can be transmitted via the transmission shaft assembly, if both a plurality of first idler gears of a first sub-transmission and a plurality of second idler gears of a second sub-transmission are rotatably mounted on the transmission shaft assembly, and if the transmission shaft assembly is designed at least in a portion as a hollow shaft.

It is particularly advantageous here if the camshaft assembly is rotatably mounted at least in a portion within the transmission shaft assembly and comprises the first camshaft assigned to the first idler gears and the second camshaft assigned to the second idler gears.

In general, it is conceivable not to arrange the transmission shaft and the camshaft coaxially. However, it is particularly advantageous if the transmission shaft assembly and the camshaft assembly are coaxially aligned with each other.

According to a further preferred embodiment, the reversing transmission comprises a planet gear set, wherein it is preferred if a first member of the planet gear set (e.g. sun gear) is coupled to the first camshaft, a second member of the planet gear set (e.g. planet carrier) is coupled to the transmission shaft assembly, and a third member of the planet gear set (e.g. ring gear) is coupled to the second camshaft.

This allows the reversing transmission to be realized in a constructively relatively simple manner. Furthermore, the reversing transmission can preferably be arranged coaxially to the transmission shaft assembly and the camshaft assembly.

It is understood that the three members of the planet gear set can also be connected differently than described above.

As will be further explained below, the use of the planet gear set inevitably establishes a transmission ratio between the first camshaft and the second camshaft. The transmission ratio is preferably selected, as will be further explained below, such that a torque increase and/or a speed reduction occurs at the second camshaft.

In this embodiment, it is preferred if only the first camshaft is driven to perform shifting operations. The second camshaft is connected to the first camshaft via the reversing transmission, so that the second camshaft is indirectly driven by a member of the reversing transmission, preferably by the ring gear.

In general, it is preferred if the shifting arrangement is used in an e-bike, in which case it is preferred if an electric motor is connected between the first sub-transmission and the second sub-transmission. Since significantly increased torques are transmitted via the second sub-transmission in this case, it is advantageous that the shifting devices of the second sub-transmission are actuated with increased shifting forces due to the transmission ratio of the planet gear set.

According to a further preferred embodiment, the shifting arrangement includes a speed-superposition transmission, via which the transmission shaft assembly and the camshaft assembly are coupled, and which can be actuated in order to achieve, for shifting the gear stages, a relative rotation of the transmission shaft assembly and the camshaft assembly.

It is particularly advantageous here if the speed-superposition transmission is coupled to the transmission shaft assembly and to one of the first and the second camshafts, preferably to the first camshaft.

The basic structure of the shifting arrangement is consequently such that the camshaft assembly and the transmission shaft assembly rotate at the same rotational speed when a gear stage is engaged. For the purpose of performing a gear shift, a relative rotation occurs between the transmission shaft assembly and the camshaft assembly, so that a shifting device assigned to a source gear stage is disengaged and a shifting device assigned to a target gear stage is engaged. After completion of the shifting operation, the transmission shaft assembly and the camshaft assembly rotate again at the same rotational speed.

The speed-superposition transmission, as described for example in document EP 2 379 402 B2, the disclosure content of which is incorporated herein by reference in this regard, can essentially be arranged on a shaft that is parallelly offset to the transmission shaft assembly.

However, it is particularly preferred if the speed-superposition transmission is arranged coaxially to the transmission shaft assembly and the camshaft assembly. It is preferred here if the speed-superposition transmission is arranged at a first axial end of the camshaft assembly.

The reversing transmission can be arranged at any position of the transmission shaft assembly or the camshaft assembly, as viewed in the axial direction.

However, it is particularly preferred if the reversing transmission is arranged at a second axial end of the camshaft assembly.

In general, the reversing transmission can be arranged on a shaft parallelly offset to the transmission shaft assembly. Preferably, however, the speed-superposition transmission is arranged coaxially thereto. It is particularly advantageous if the reversing transmission is arranged radially inside the transmission shaft assembly. This results in a particularly compact design.

The first sub-transmission is preferably arranged axially adjacent to a first axial end of the camshaft assembly. The second sub-transmission is preferably arranged axially adjacent to a second axial end of the camshaft assembly.

In general, it is conceivable that the first camshaft and the second camshaft are adjacent to each other in the axial direction.

In a particularly preferred embodiment, which constitutes a separate disclosure in conjunction with a shifting arrangement for a vehicle transmission, in particular for a transmission of a vehicle that can be driven by muscle power and/or by motor power, comprising a transmission shaft assembly, on which a plurality of idler gears are rotatably mounted, which can be connected to the transmission shaft assembly via respective shifting devices, wherein the shifting devices can be actuated by means of a camshaft assembly, which comprises a first camshaft, a second camshaft is formed as a hollow shaft and is rotatably mounted on an axial portion of the first camshaft.

This results in an axially compact design. Furthermore, the connection to a reversing transmission can be realized in a constructively relatively simple manner.

According to a further preferred embodiment, which constitutes a separate disclosure in conjunction with a shifting arrangement for a vehicle transmission, in particular for a transmission of a vehicle that can be driven by muscle power and/or by motor power, comprising a transmission shaft assembly, on which a plurality of idler gears are rotatably mounted, which can be connected to the transmission shaft assembly via respective shifting devices, wherein the shifting devices can be actuated by means of a camshaft assembly, which comprises a first camshaft, the first camshaft and a second camshaft are coupled to one another via a ratio-changing transmission, such that a rotation of one of the camshafts by a first rotation angle leads to a rotation of the other camshaft by a second rotation angle, which differs from the first rotation angle.

As explained above, the reversing transmission is preferably realized such that it also has the function of a ratio-changing transmission, in particular for reduction.

In general, the idea of coupling the two camshafts via a ratio-changing transmission is, however, also advantageous if the first and second camshafts generally rotate in the same direction, i.e., are not coupled to one another via a reversing transmission.

It is preferred here if the ratio-changing transmission is designed such that the second rotation angle is smaller than the first rotation angle. In this case, a higher shifting force can be realized in the second sub-transmission, which is appropriate for a torque increase by an electric motor.

Furthermore, it is preferred if the ratio-changing transmission has a transmission ratio in a range of 2 to 4, preferably a transmission ratio of 3.

Furthermore, it is preferred if the second rotation angle is equal to the first rotation angle divided by the transmission ratio of the ratio-changing transmission, i.e., for example, W2=W1/3 (e.g., 20°=60°/3).

According to a further preferred embodiment, the first camshaft is rotatable by 360° or more and the second camshaft is rotatable over an angular range that is smaller than 360°.

With an assumed transmission ratio of 3, it is thus possible, for example, to cover all gear stages by a rotation of the first camshaft by 900°, and by a corresponding rotation of the second camshaft by 300°, or by angles that are proportional thereto.

If, for example, the first sub-transmission has four sub-transmission gear stages, it is advantageous if these four sub-transmission gear stages are arranged over an angular range of less than 360°, e.g., 180°. Over the 180°, the gear stages 1 to 4 can then be established. If the second sub-transmission has, for example, three sub-transmission gear stages, the first camshaft can then be rotated by a further 180°, for example, in order to shift from the fourth sub-transmission gear stage in the first sub-transmission back to the first sub-transmission gear stage of the first sub-transmission, which now, with the second sub-transmission simultaneously shifted into its second sub-transmission gear stage, represents gear stage 5 of the overall transmission.

If the first four gear stages are arranged over 180°, this results in shift rotation angles of 60° for each gear shift. If the transmission ratio in the ratio-changing transmission is 3, the shifting operation in the first sub-transmission from sub-transmission gear stage 4 to sub-transmission gear stage 1 over 180° can correspond to a shifting operation of 60° in the second sub-transmission.

According to a particularly preferred embodiment, which constitutes a separate disclosure in conjunction with a shifting arrangement for a vehicle transmission, in particular for a transmission of a vehicle that can be driven by muscle power and/or by motor power, comprising a transmission shaft assembly, on which a plurality of idler gears are rotatably mounted, which can be connected to the transmission shaft assembly via respective shifting devices, wherein the shifting devices can be actuated by means of a camshaft assembly, which comprises a first camshaft, each gear shift in the first sub-transmission is thus assigned a respective first shift rotation angle of the first camshaft, wherein each gear shift in a second sub-transmission is assigned a respective second shift rotation angle of a second camshaft, wherein the first shift rotation angle (e.g., 60°) of at least one sub-transmission gear shift in the first sub-transmission is equal to the second shift rotation angle (e.g., 60°) of at least one sub-transmission gear shift in the second sub-transmission.

In other words, the kinematics/geometry for the gear shifts between the first sub-transmission and the second sub-transmission can be unified, so that synergy effects arise in the production of the shifting devices and the camshafts.

The subdivision is preferably chosen, as mentioned above, such that the total angle of the shifting operations in the first sub-transmission results in exactly 360°. Consequently, a repetition of this shifting scheme in the first sub-transmission can then be achieved over several revolutions of the first camshaft. For example, the subdivision for four sub-transmission gear stages can be set to a shift rotation angle of 60°, so that upon reaching sub-transmission gear stage 4, 180° have been covered ((4 sub-transmission gear stages−1)×60°) and that from gear stage 4 back to sub-transmission gear stage 1, the remaining angle of 180° is then rotated.

The second camshaft is preferably designed such that the sub-transmission gear stage in the second sub-transmission remains set while the sub-transmission gear stages in the first sub-transmission are shifted through.

Generally speaking, a transmission ratio between the first sub-transmission (TG1) and the second sub-transmission (TG2) can be calculated as follows, if the divisions in TG1 and TG2 are to be identical:

$$360 ° - ( Number of gear stages TG 1 - 1 ) \times Subdivision TG 1 = Transmission ratio \times Division TG 2$$

For example, with four sub-transmission gear stages in TG1 and a subdivision TG1 of 60° and a desired identical division TG2 of 60°, this results in a transmission ratio of 3:

$$( 360 ° - ( 4 - 1 ) \times 60 ° = i \times 60 ° )$$

With three sub-transmission gear stages in TG1 and a division TG1 of 90° and a desired identical division TG2 of 90°, this results, for example, in a transmission ratio of 2:

$$( 360 ° - ( 3 - 1 ) \times 90 ° = i \times 90 ° )$$

With five sub-transmission gear stages in TG1 and a division TG1 of 45° and a desired identical division TG2 of 45°, this results, for example, in a transmission ratio of 4:

$$( 360 ° - ( 5 - 1 ) \times 45 ° = i \times 45 ° )$$

According to a further preferred embodiment, which constitutes a separate disclosure in conjunction with a shifting arrangement for a vehicle transmission, in particular for a transmission of a vehicle that can be driven by muscle power and/or by motor power, comprising a transmission shaft assembly, on which a plurality of idler gears are rotatably mounted, which can be connected to the transmission shaft assembly via respective shifting devices, wherein the shifting devices can be actuated by means of a camshaft assembly, which comprises a first camshaft, the first camshaft and a second camshaft are coupled to one another via a torque-changing transmission, such that a rotation of one of the camshafts with a first torque leads to a rotation of the other camshaft with a second torque, which differs from the first torque.

As mentioned above, a ratio-changing transmission that provides a reduction (such that the second camshaft rotates proportionally to the first camshaft, but slower), inevitably results in a torque increase at the second sub-transmission.

This advantageous configuration can, as mentioned, be used to simplify the use in e-bikes. Because of the higher torque of the camshaft acting on the shifting device, the shifting device can consequently be brought out of engagement under higher load when disengaging a gear stage, which is particularly advantageous in the use of e-bikes.

Overall, it is advantageous if the ratio-changing transmission is formed by the reversing transmission and/or if the torque-changing transmission is formed by the reversing transmission.

According to a further, overall preferred embodiment, which constitutes a separate disclosure in conjunction with a shifting arrangement for a vehicle transmission, in particular for a transmission of a vehicle that can be driven by muscle power and/or by motor power, comprising a transmission shaft assembly, on which a plurality of idler gears are rotatably mounted, which can be connected to the transmission shaft assembly via respective shifting devices, wherein the shifting devices can be actuated by means of a camshaft assembly, which comprises a first camshaft, at least one shifting device is formed as a shifting pawl, which is radially pivotably mounted on the transmission shaft assembly and which can be actuated by means of a functional cam body of the camshaft assembly between a pivoted-in position and a gear position, wherein the functional cam body is designed as a cam body that is rotatably mounted in a limited manner between a first functional stop and a second functional stop.

Through this configuration, it is possible that the functional cam body initially does not co-rotate during a rotation of the camshaft assembly, until it is forcibly made to co-rotate from a certain rotational position of the camshaft assembly due to a functional stop.

In a more general form, this preferred configuration is defined by a separate disclosure in the form of a method according to claim 19 for connecting two relatively rotatable rotating members that can be connected by means of a shifting device, while they rotate relative to each other, by means of a camshaft which comprises a functional cam body that (i) is resiliently rotatable relative to a basic position on the camshaft and (ii) is designed to actuate the shifting device, wherein the camshaft assembly is rotated to connect the relatively rotating rotating members, but the functional cam body initially does not co-rotate until it is forcibly made to co-rotate from a certain rotational position of the camshaft assembly and then is resiliently rotated back into the basic position.

The functional cam body can be assigned to a single gear stage, but can also be formed by a cam body assigned to several gear stages (e.g., second camshaft).

Preferably, the functional cam body initially does not co-rotate during a rotation of the camshaft assembly by being held with respect to one of the rotating members or with respect to the shifting device.

With this method, essentially two advantages can be realized.

On the one hand, the risk that the shifting device or the shifting pawl only partially engages in the internal toothing of an idler gear when engaging a gear stage can be reduced. This can occur, for example, in conventional designs, especially when the camshaft rotates relatively slowly and the shifting pawl is only hesitantly pivoted out, e.g., during an upshift. This applies in particular to the second sub-transmission, whose camshaft preferably rotates more slowly than the first camshaft by the factor of a transmission ratio (of, for example, 3).

The second advantageous aspect resulting from the rotatability of the functional cam body with respect to the assigned camshaft is the backlash/clearance compensation that can be realized thereby, in particular between the first camshaft and the second camshaft.

In other words, an asymmetrical camshaft timing can be realized through the rotatability of the functional cam body.

Such asymmetrical camshaft timing is understood to mean that the rotation angle and thus the “timing” of the respective shifting device actuation during downshifting differs from that during upshifting. The rotation angle-dependent angular positions at which certain shifting devices (e.g., shifting pawls) pivot out or in can thus be different for upshifting than for downshifting.

The functional cam body, which is rotatable between two functional stops relative to the assigned camshaft, is preferably prestressed against one of the functional stops by means of a functional spring in such a way that the functional cam body remains at this first functional stop during downshifts.

On the other hand, it is preferred if the functional cam body is rotated against the action of such a functional spring during upshifts (i.e., does not co-rotate).

Hereby, the functional cam body can initially not co-rotate until it is forcibly made to co-rotate from a certain rotational position of the camshaft (in particular upon reaching the second functional stop) and is then rotated back into the basic position, in particular resiliently by means of the functional spring.

Hereby, it can be achieved that the shifting device is quickly pushed outwards by the functional cam body, which is quickly actuated by the force of the functional spring, so that a secure engagement into an internal toothing of an idler gear is also guaranteed when the functional cam body otherwise rotates relatively slowly.

According to a further preferred embodiment, the angle between the first functional stop and the second functional stop is selected such that it compensates at least a circumferential play that is present between the functional cam body and the assigned camshaft.

Such circumferential play is particularly present when the first camshaft and the second camshaft are not rigidly connected to each other, but via connecting device. Such a play arises in particular when the first camshaft and the second camshaft are coupled via a transmission, thus in particular a ratio-changing transmission or a reversing transmission.

According to a further preferred embodiment, the angle between the first functional stop and the second functional stop is selected such that it is adapted to a relative rotatability between the functional cam body and the assigned camshaft, for example, to a transmission ratio between the first camshaft and the second camshaft.

Preferably, this angle lies in a range of 5° to 20°, but can also lie in a range of 50° to 80°, depending on whether a transmission ratio between the first camshaft and the second camshaft is also to be compensated by means of this angle.

Furthermore, it is advantageous if this angle is selected such that it enables an engaging of a target gear stage that is independent of a shifting contour of the cam body.

Hereby, as said, a kind of “pre-tensioning” of the shifting device can occur, which can then be abruptly pushed into the internal toothing of the idler gear from the moment of forced co-rotation, without a “rolling” of a shifting device on a shifting contour (or vice versa) having to occur.

Hereby, it can be achieved that the shifting device always fully engages in the internal toothing of the gear wheel, in particular down to a tooth root. The wear of the shifting device and the internal toothing can be reduced hereby.

In general, such a functional cam body can be assigned to each gear stage of the first sub-transmission.

However, it is particularly advantageous if the functional cam body is assigned to the highest gear stage of the first sub-transmission.

According to a further preferred embodiment, which constitutes a separate disclosure in conjunction with a shifting arrangement for a vehicle transmission, in particular for a transmission of a vehicle that can be driven by muscle power and/or by motor power, comprising a transmission shaft assembly, on which a plurality of idler gears are rotatably mounted, which can be connected to the transmission shaft assembly via respective shifting devices, wherein the shifting devices can be actuated by means of a camshaft assembly, which comprises a first camshaft, the second camshaft is rotatably mounted with respect to the first camshaft in a limited manner between a first coupling stop (corresponding to a first functional stop) and a second coupling stop (corresponding to a second functional stop) and is prestressed against the first coupling stop by means of a coupling spring (corresponding to a functional spring).

Hereby, the second camshaft as a whole forms a functional cam body, which is particularly advantageous because the second camshaft rotates more slowly compared to the first camshaft and consequently the “pre-tensioning” in the second sub-transmission is of particularly advantageous importance.

In the second sub-transmission, the cam bodies are preferably all rigidly connected to the second camshaft, so that it forms the cam bodies for all gear stages of the second sub-transmission.

It is particularly advantageous if the second camshaft may be held with respect to the transmission shaft assembly in a plurality of detent positions by means of a detent arrangement.

Hereby, the coupling spring can be equipped with a comparatively large spring force, which can ensure a quick pivoting out of a shifting pawl. Because the second camshaft is preferably held in a respective detent position in this case, so that the second camshaft initially does not co-rotate during a rotation of the first camshaft, until a certain rotational position of the first camshaft is reached, due to which a stop is reached, by which the second camshaft is taken along and the detent arrangement is released.

In a cam body that is assigned to a single idler gear, which is arranged in the first sub-transmission (such as, for example, an idler gear for the highest gear stage of the first sub-transmission), either such a detent arrangement can also be provided between the cam body and the transmission shaft assembly, and/or a torsion spring element that counteracts a co-rotation of the cam body.

Overall, at least one of the following basic ideas is disclosed herein:
   | an opposite rotation direction of camshafts of series-connected, shiftable sub-transmissions is realized, namely via a reversing transmission, so that the camshafts do not have to be driven independently of one another,
┘ individual cam bodies are held and pre-tensioned in order to achieve an instantaneous release of a shifting device upon exceeding a certain rotation angle of the camshaft,
┘ a cam body and/or a camshaft is designed to pivot shifting devices in or out at different rotation angle positions depending on the direction of rotation, consequently an “asymmetrical camshaft timing”,
] a backlash compensation of different camshaft directions is achieved by a pre-tensioning mechanism on cam bodies or (sub-) camshafts.

It is understood that the features of the disclosure mentioned above and those to be explained below are usable not only in the respectively indicated combination, but also in other combinations or in isolation, without departing from the scope of the disclosure.

### DRAWINGS

Further features and advantages of the disclosure will become apparent from the following description of preferred exemplary embodiments with reference to the drawings, where:

FIG. 1 is a schematic representation of a bicycle frame with a transmission unit in the area of the crank arms;

FIG. 2 is a schematic layout of a transmission unit;

FIG. 3 is a schematic representation of a speed-superposition transmission of a shifting arrangement;

FIG. 4 is a perspective view of a switchable idler gear with an internal toothing;

FIG. 5 is a perspective view of a shifting device in the form of a shifting pawl or freewheel body, which can be pivotably mounted on a transmission shaft assembly;

FIGS. 6a-6f are schematic cross-sectional views of a shifting arrangement for illustrating a shifting operation from a source gear stage to a target gear stage;

FIG. 7 is a perspective view of an embodiment of a shifting arrangement;

FIG. 8 is a schematic longitudinal sectional view of the shifting arrangement of FIG. 7;

FIG. 9 is a perspective exploded view of the shifting arrangement of FIG. 7;

FIG. 10 is a schematic exploded view of the shifting arrangement of FIG. 7 with an enlarged representation of a first sub-transmission;

FIG. 11 is a schematic perspective view of a first camshaft of the shifting arrangement of FIG. 7; and

FIGS. 12a and 12b are schematic representations of two camshafts and their rotation angles in relation to gear stages.

### DETAILED DESCRIPTION

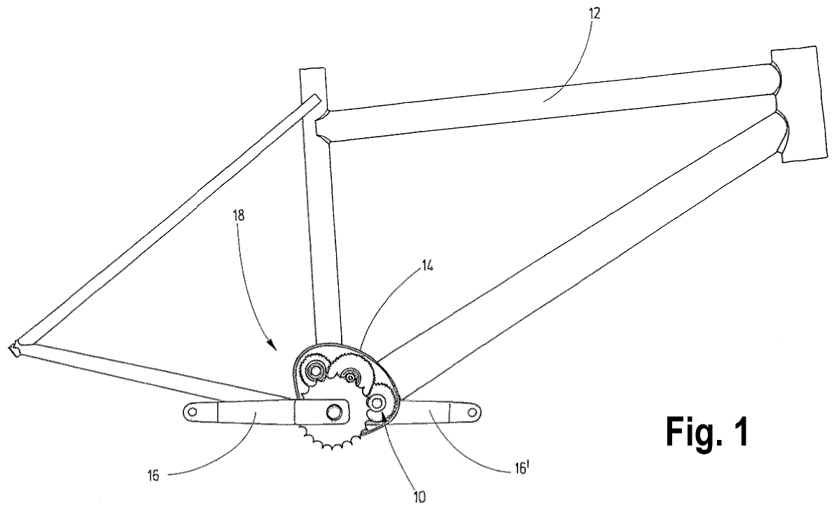

In FIG. 1, a transmission unit is generally designated by 10.

FIG. 1 shows a side view of a bicycle frame 12, which has a transmission housing 14, in which the transmission unit 10 is received. The transmission unit 10 is only schematically indicated in this representation and is designed as a compact unit, which is preferably arranged in a transmission cage, not shown here. The transmission unit 10 is described herein by way of example for use in a two-wheeled vehicle, although use in other vehicles driven by muscle power is also possible. It is understood that transmission unit 10 can also be used for vehicles that are driven by muscle power in combination with a drive machine, or that are driven exclusively by means of such a drive machine. The drive machine is preferably an electric motor, the vehicle is preferably an e-bike or a pedelec.

The transmission unit 10 and the transmission housing 14, together with crank arms 16 and 16′, form a multi-speed transmission 18.

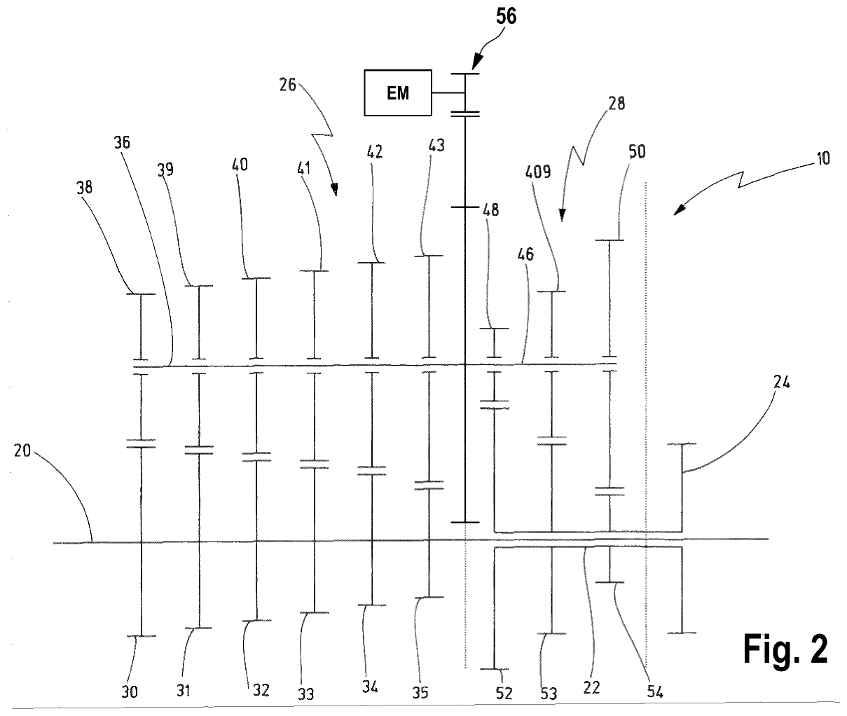

FIG. 2 shows a schematic layout of the transmission unit 10.

The transmission unit 10 has an input shaft 20 and an output shaft 22. The input shaft 20 is designed as a through-shaft and can be non-rotatably connected to crank arms. The output shaft 22 is designed as a hollow shaft. The input shaft 20 and the output shaft 22 are arranged coaxially to each other. The output shaft 22 is non-rotatably connected to a chainring 24, which forms an output member of the transmission unit 10.

The transmission unit 10 has a first sub-transmission 26 and a second sub-transmission 28. A plurality of drive gears 30, 31, 32, 33, 34, 35 are mounted on the input shaft 20. The first sub-transmission 26 has a countershaft 36. On the countershaft 36, driven gears 38, 39, 40, 41, 42, 43 are mounted. The driven gears 38 to 43 are designed as first idler gears.

The driven gears 38 to 43 are each connectable to the countershaft 36 by means of first shifting devices, not shown. The driven gears 38 to 43 and the drive gears 30 to 35 each form gear pairs which have different transmission ratios, so that by selectively connecting the driven gears 38 to 43 with the countershaft 36, different gear stages can be realized in the first sub-transmission 26.

The second sub-transmission 28 has an input shaft 46. On the input shaft 46, drive gears 48, 49, 50 are mounted. The drive gears 48 to 50 are designed as second idler gears. On the output shaft 22, driven gears 52, 53, 54 are mounted. The driven gears 52 to 54 are each in meshing engagement with the drive gears 48 to 50.

By the respectively meshing driven gears 52 to 54 and drive gears 48 to 50, gear pairs are formed which have different transmission ratios. The drive gears 48 to 50 are non-rotatably connectable to the input shaft 46 by means of second shifting devices, not shown, whereby different, selectable gear stages of the second sub-transmission 28 are formed.

The countershaft 36 of the first sub-transmission 26 is preferably non-rotatably connected to the input shaft 46 of the second sub-transmission 28. Preferably, the countershaft 36 is integrally formed with the input shaft 46.

Preferably, the drive gears 30 to 35 are each connected to the input shaft 20 by means of a clutch, not shown, in a force-locking manner and in particular by means of a friction clutch in a friction-locking manner. The clutch is designed to limit a torque introduced into the transmission unit 10. The clutch is designed such that, if a predefined or adjustable torque is exceeded, the connection between the input shaft 20 and the corresponding drive gear 30 to 35 slips. By means of such a torque limitation, the size and weight of the transmission unit can be reduced, since the transmission unit can be designed for a lower maximum torque. The drive gears 30 to 35 can also be connected to the input shaft 20 via a torque-sensing arrangement (not shown), in order to detect, for example, a torque introduced into the input shaft 20 by muscle power. The detected torque can be used to control an assisting drive motor.

Because the first sub-transmission 26 is connected “serially” with the second sub-transmission 28, the possible realizable gear stages of the first sub-transmission 26 multiply with the gear stages of the second sub-transmission 28, in the manner of a range-type transmission. Thus, eighteen gears can be realized by the transmission unit 10 shown in FIG. 2.

Furthermore, it is conceivable that the input shaft 20 is non-rotatably connectable to the output shaft 22 by means of a clutch, not shown. Thereby, a further gear as a direct drive gear would be realizable.

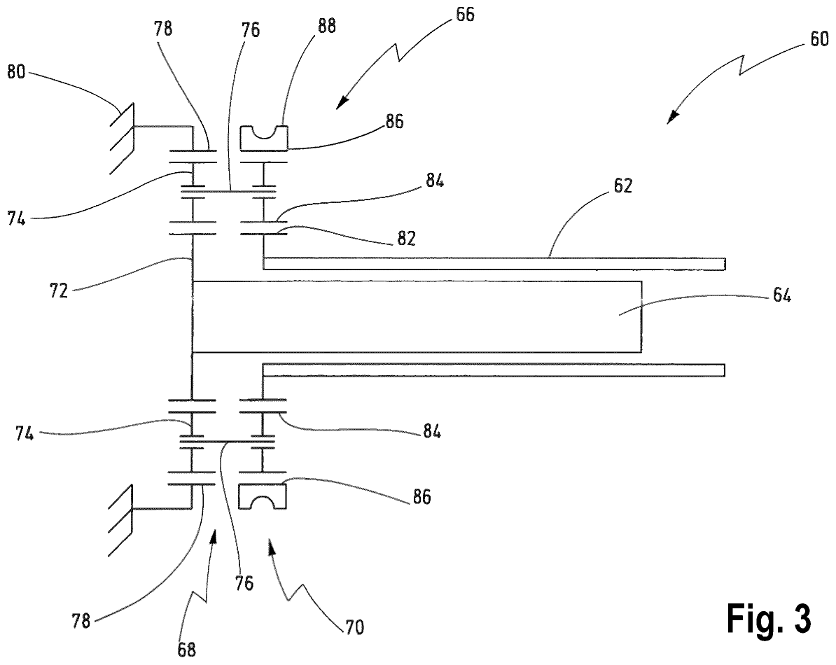

In FIG. 3, a schematic layout of a shifting arrangement with a rotatable camshaft is schematically shown. In FIG. 3, a shifting arrangement is generally designated by 60.

The shifting arrangement 60 generally serves to selectively connect idler gears, not shown, mounted on a shaft 62, to the shaft 62 in a drive rotation direction by means of shifting devices, not shown, such as shifting pawls. The shifting arrangement 60 has a camshaft 64, which is arranged coaxially in the shaft 62, which is designed as a hollow shaft, and is rotatably mounted relative thereto. At an axial end of the shaft 62 (or parallelly offset thereto), a speed-superposition transmission 66 is arranged, which is connected to both the shaft 62 and the camshaft 64. The speed-superposition transmission 66 is preferably arranged coaxially to the shaft 62. The speed-superposition transmission 66 includes a transfer stage 68 and a control stage 70. The control stage 70 is connected to the shaft 62 and the transfer stage 68 is connected to the camshaft 64. Alternatively, the control stage 70 can be connected to the camshaft 64 and the transfer stage 68 to the shaft 62. The transfer stage 68 is formed by a first planetary transmission 68, in particular in the form of a planetary gear set. The control stage 70 is formed by a second planetary transmission 70, in particular in the form of a planetary gear set. The first planetary transmission 68 has a sun gear 72, which is non-rotatably connected to the camshaft 64. The first planetary transmission 68 has planet gears 74, which are mounted on a planet carrier 76. The planet gears 74 mesh with the sun gear 72. The first planetary transmission 68 has a ring gear 78, with which the planet gears 74 also mesh. The ring gear 78 is fixed to a fixed reference point 80, preferably a transmission cage or transmission housing, not shown, and is fixedly connected to it.

The second planetary transmission 70 has a sun gear 82, which is non-rotatably connected to the shaft 62. The second planetary transmission 70 has planet gears 84, which are mounted on the planet carrier 76. The planet gears 84 mesh with the sun gear 82. The second planetary transmission 70 has a ring gear 86, with which the planet gears 84 also mesh. The ring gear 86 is non-rotatably connected to a traction disc 88, to which a Bowden cable, not shown, can be attached.

The first planetary transmission 68 and the second planetary transmission 70 are dimensioned such that with a stationary or fixed ring gear 86, the transmission ratio from the shaft 62 to the camshaft 64 is exactly or precisely 1, so that in this case the shaft 62 and the camshaft 64 rotate synchronously or at the same rotational speed. The second planetary transmission 70 or the control stage 70, respectively, serves to superimpose an additional rotational speed on the rotational speed of the shaft 62. This additional rotational speed is transmitted via the ring gear 86 to the planet carrier 76. Because the planet gears 84 of the second planetary transmission 70 and the planet gears 74 of the first planetary transmission 68 are connected via a planet carrier 76, a total rotational speed as a sum of the rotational speed of the shaft 62 and the rotation of the ring gear 86 is transmitted to the first planetary transmission 68. The first planetary transmission 68 or the transfer stage 68, respectively, serves to transmit the total rotational speed to the camshaft 64. The ring gear 86 is non-rotatably connected to the traction disc 88, in order to be actuated by means of a Bowden cable, not shown. In doing so, the traction disc 88 is rotated by a certain rotation angle in the direction of rotation of the shaft 62 or against the direction of rotation of the shaft 62, in order to transmit this relative movement to the camshaft 64. This allows the gears of the transmission unit 10 to be shifted by actuating the Bowden cable. The sun gear 62 is preferably formed as part of the shaft 62 or integrally with the shaft 62.

In an alternative embodiment, the two ring gears 78, 86 are freely rotatably mounted and non-rotatably connected to each other. In this embodiment, the planet gears 74, 84 are each connected by means of a separate planet carrier. In this case, one of the planet carriers is connected to the traction disc 88 in order to transmit the rotation of the traction disc 88 to the camshaft 64.

In a further alternative embodiment, it is also conceivable that the sun gears are non-rotatably connected to each other and are freely rotatably mounted. In this case, the shaft 62 would be connected to the planet carrier of the planet gears 84 and the camshaft 64 to the planet carrier of the planet gears 74.

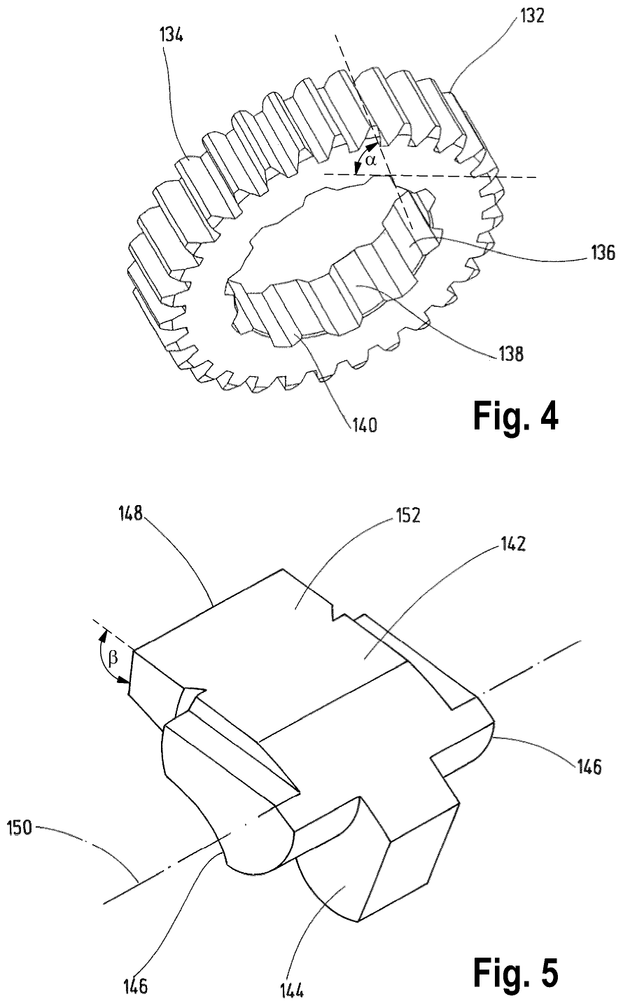

In FIG. 4, a switchable idler gear with internal toothing is shown and generally designated by 132.

The idler gear 132 has an external toothing 134 and an internal toothing 136. The external toothing 134 is formed on the outer circumferential surface. The internal toothing is formed on an inner circumferential surface of the idler gear 132. The internal toothing 136 has sliding portions 138 and engagement portions 140. The sliding portions 138 are formed by surfaces formed in the circumferential direction of the idler gear 132. Between the sliding portions 138, the engagement portions 140 are formed at an angle to the sliding portions 138.

The external toothing 134 serves to mesh with other gear wheels. The internal toothing 136 serves to mount the idler gear 132 on the shaft 62 and to non-rotatably connect it to the shaft 62 by means of shifting devices. The sliding portions 138 serve to rotatably mount the idler gear 132 on the shaft 62 and to slide on the shaft 62. The engagement portions 140 serve to allow shifting devices, not shown, which will be explained in more detail below, to be brought into engagement with the idler gear 132 and to non-rotatably connect the idler gear 132 with the shaft 62.

In FIG. 5, a shifting device in the form of a freewheel body or a shifting pawl, respectively, for non-rotatably connecting the idler gear 132 with the shaft 62 is shown and generally designated by 142. The freewheel body 142 has an actuation portion 144, which is formed on a lower side or radially inner side of the freewheel body 142. The freewheel body 142 has a bearing portion 146 on each of two axially lateral sections. The freewheel body 142 has an engagement portion 148. The engagement portion 148 is formed at an end of the freewheel body 142 opposite the actuation portion 144 in the circumferential direction. The bearing portions 146 are arranged in the circumferential direction between the actuation portion 144 and the engagement portion 148.

The bearing portions 146 serve to rotatably or pivotably mount the freewheel body 142 on a shaft (e.g., the shaft 62 in FIG. 3) about a rotational axis 150. The freewheel body 142 is mounted on the shaft such that the actuation portion 144 points towards the interior of the shaft. Furthermore, the freewheel body 142 is pre-stressed by means of a spring element, not shown, such that the actuation portion 144 is pivoted radially inwards in the unloaded state and the engagement portion 148 is pivoted radially outwards. The actuation portion 144 serves to be pushed radially outwards by means of a cam 111 of the camshaft 64, in order to pivot the engagement portion 148 radially inwards about the rotational axis 150.

If the engagement portion 148 is pivoted radially outwards and protrudes from the shaft, it can be brought into engagement with the engagement portion 140 of the internal toothing 136 of the idler gear 132 in one direction of rotation of the idler gear 132 and thus non-rotatably connect the idler gear with the shaft in a drive rotation direction.

The freewheel body 142 further has a sliding portion 152. The sliding portion 152 serves to pivot the freewheel body 142 radially inwards, if the idler gear is rotated relative to the shaft in a direction opposite to the drive rotation direction, and thus to serve as a freewheel.

The actuation portion 144 can have a groove running perpendicular to the rotational axis 150 or in the direction of rotation of the shaft, in order to accommodate a spring element for pre-stressing the freewheel body 142.

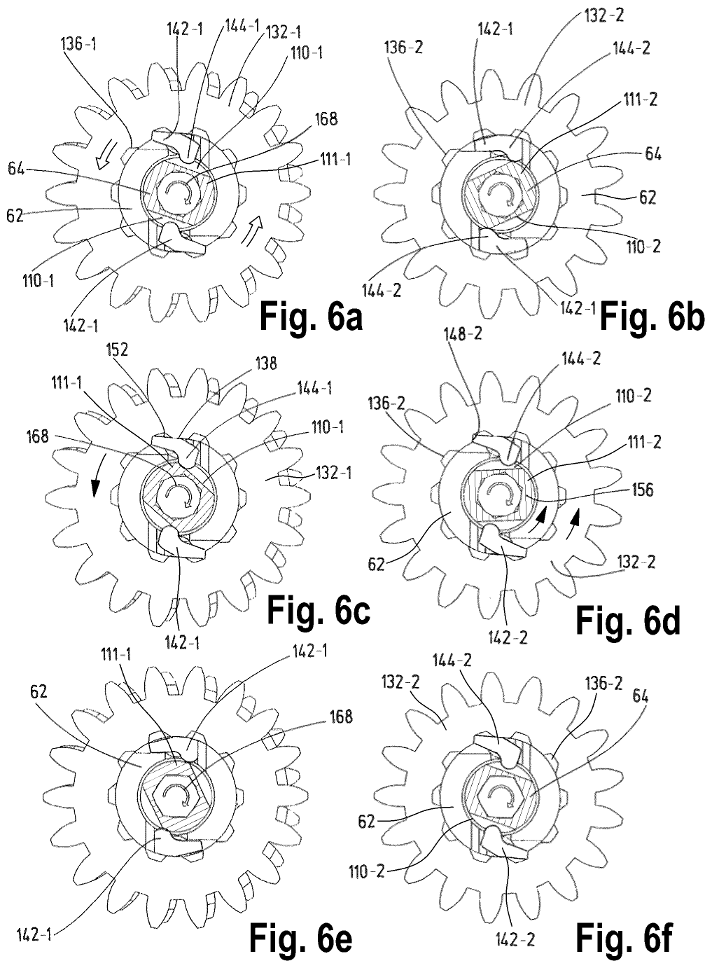

In FIGS. 6a to 6f, a gear shift between a source gear stage (e.g., gear stage 1) and a target gear stage (e.g., gear stage 2) is schematically shown. For this purpose, radial sectional views through idler gears 132-1 and 132-2 are shown, which correspond to the source gear stage and the target gear stage, respectively, during three states (FIGS. 6a and 6b, FIGS. 6c and 6d, and FIGS. 6e and 6f) of the gear shift.

FIG. 6a shows the idler gear 132-1 assigned to the source gear stage, whose internal toothing 136-1 is in engagement with the two assigned freewheel bodies 142-1. The camshaft 64 is positioned relative to the shaft 62 in a rotational position such that cam gaps 110-1 of the camshaft 64 are arranged in the area of the actuation portions 144-1 of the freewheel bodies 142-1, and so the freewheel bodies 142-1 can pivot outwards. The source gear stage is engaged.

The idler gear 132-2 assigned to the target gear stage is shown in FIG. 6b. The freewheel bodies 142-2 are pivoted radially inwards by cams 111-2 and are therefore not in engagement with the internal toothing 136-2 of the idler gear 132-2. In this rotational position of the camshaft 64, cam gaps 110-2, which are assigned to the target gear stage, are not arranged under the actuation portions 144-2 of the freewheel bodies 142-2, so that the actuation portions 144-2 are pushed outwards by means of the cams 111-2. The target gear stage is disengaged.

Starting from the state of FIGS. 6a and 6b, if the camshaft 64 is rotated, as indicated by an arrow 168, the cam gaps 110-1 initially remain below the freewheel bodies 142-1, which are assigned to the idler gear 132-1, in a second, or intermediate, state. The source gear stage remains engaged in the second state, as shown in FIG. 6c, and the freewheel bodies 142-1 remain pivoted out.

In FIG. 6d, the idler gear 132-2 assigned to the target gear stage is shown in this second state. In this rotational position of the camshaft 64, the cam gaps 110-2, which are assigned to the target gear stage, are arranged radially below the actuation portions 144-2 of the freewheel bodies 142-2, so that the actuation portions 144-2 can pivot radially inwards and thus the engagement portions 148-2 can pivot radially outwards. As a result, the engagement portions 148-2 are brought into engagement with the internal toothing 136-2 of the idler gear 132-2. Now the target gear stage is also engaged.

The freewheel bodies 142 are each assigned a spring, not shown, which prestresses the respective freewheel body 142 such that the respective actuation portion 144 is pressed against the camshaft 64. As a result, the respective engagement portion 148 pivots radially outwards, provided one of the cam gaps 110 is rotated under the shifting pawl 142.

Since the target gear stage is a higher gear stage with a smaller transmission ratio, the shifting pawls 142-2 of the target gear stage engage in the internal toothing 136-2 of the assigned idler gear 132-2 and drive the shaft 62 at a rotational speed that is lower than the rotational speed of the idler gear 132-1 of the source gear stage. Therefore, the idler gear 132-1 of the source gear stage “overtakes” the shaft 62 in this so-called intermediate state. As a result, the sliding portion 138 of the idler gear 132-1 presses against the sliding portion 152 of the freewheel body 142-1, so that the freewheel body 142-1 is deflected inwards and the idler gear 132-1 slides on the shaft 62. The idler gear 132-1 of the lower gear, i.e., the first gear, is in freewheel mode in the intermediate state.

In FIGS. 6e and 6f, the state is shown in which the target gear stage is fully engaged. For this purpose, the camshaft 64 has been further rotated in the direction of the arrow 168, so that the freewheel bodies 142-1 of the source gear stage are pivoted in by the cams 111-1 of the camshaft 64, as shown in FIG. 6e. In FIG. 6f, it is shown that the freewheel bodies 142-2 of the target gear stage remain in engagement with the internal toothing 136-2 of the idler gear 132-2 because the cam gaps 110-2 are arranged below the actuation portions 144-2 of the freewheel bodies 142-2.

Through the intermediate state, in which the freewheel bodies 142-1, 142-2 of two gear stages are radially pivoted out, shifting under load is possible. Furthermore, a neutral state is avoided.

When downshifting from a high source gear stage (e.g., gear stage 2 in FIG. 6f) to a low target gear stage (e.g., gear stage 1 in FIG. 6a), the sliding portion 138 of the internal toothing 136-1 of the target gear stage's gear initially slides over the freewheel bodies 142-1 in the intermediate state. The higher gear remains engaged for the time being. The freewheel bodies 142-2 are only pivoted in, or the source gear stage is disengaged, when the load transmitted via the idler gear 132-2 to the shaft 62 is removed. Additionally, the camshaft 64 must then be further rotated so that the actuation portion 144-2 is pushed outwards. The lower target gear stage is then immediately engaged because this gear stage has already been in the freewheel state since the intermediate state (FIG. 6c). This avoids a neutral state.

In FIGS. 6a to 6f, the camshaft 64 is shown with exactly opposite cams 111. Alternatively, it is also conceivable that the cams 111 are arranged relative to each other such that only one of the freewheel bodies is brought into engagement with the respective internal toothing 136. This is realized by arranging the respective freewheel bodies 142 on the shaft 64 not exactly opposite each other. This can reduce the rotation angle of the respective idler gear 132 until the engagement portion 148 latches into the internal toothing 136. In an alternative embodiment, only one freewheel body 142 and the associated actuation element, only one cam 111 or one cam gap 110, respectively, is assigned to a respective idler gear.

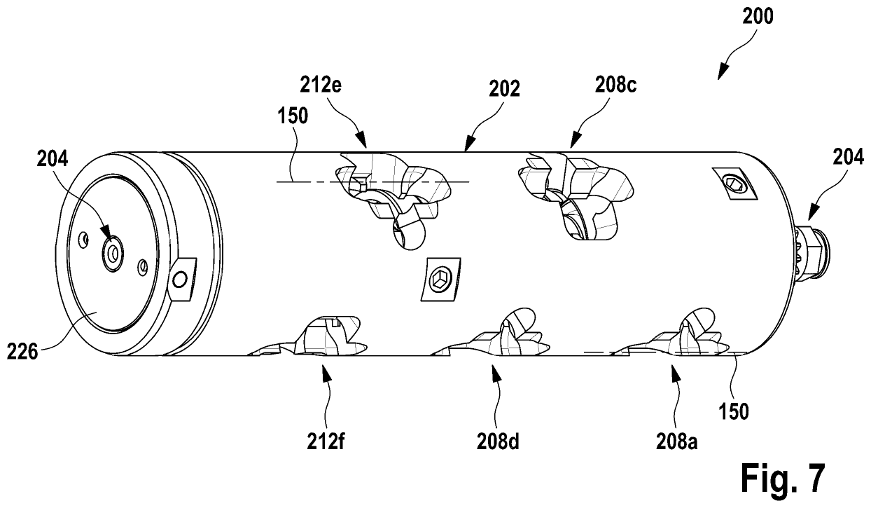

In FIGS. 7 to 11, an embodiment of a shifting arrangement is shown which can be used for a transmission unit as described above.

The shifting arrangement 200 includes a transmission shaft assembly 202, which can correspond, for example, to the countershaft 36 of FIG. 2 or the shaft 62 of FIG. 3.

The shifting arrangement 200 further includes a camshaft assembly 204, which includes a first camshaft 64A and a second camshaft 64B.

The first camshaft 64A is designed as a solid shaft and extends essentially over the entire axial length of the shifting arrangement 200. At a first end E1, the transmission shaft assembly 202 and the first camshaft 64A are coupled to each other via a speed-superposition transmission 66, as has been described with reference to FIG. 3.

On the first camshaft 64A, which is assigned to a first sub-transmission 26, a plurality of cam bodies 206a, 206b, 206c, 206d are mounted. The first sub-transmission has four sub-transmission gear stages. The cam bodies 206a, 206b, 206c, which are assigned to the sub-transmission gear stages 1 to 3 of the first sub-transmission 26, are non-rotatably connected to the first camshaft 64A.

The cam body 206d is, as will be described below, mounted rotatably in a limited manner on the first camshaft 64A.

The cam bodies 206 each have cams 111 and intervening cam gaps 110, as described above with reference to FIG. 6.

Each of the cam bodies 206 is assigned a bearing portion 208a, 208b, 208c, 208d on the transmission shaft assembly 202, on which respective freewheel bodies or shifting pawls are pivotably mounted, as described above with reference to FIG. 5. The pivot axes 150 of these bearing portions 208 are schematically indicated in FIG. 7. The pivot or rotational axes 150 are oriented parallel to an axis of the transmission shaft assembly 202.

The cam bodies 206 of the first sub-transmission 26 are arranged adjacent to the first axial end E1 of the first camshaft 64A.

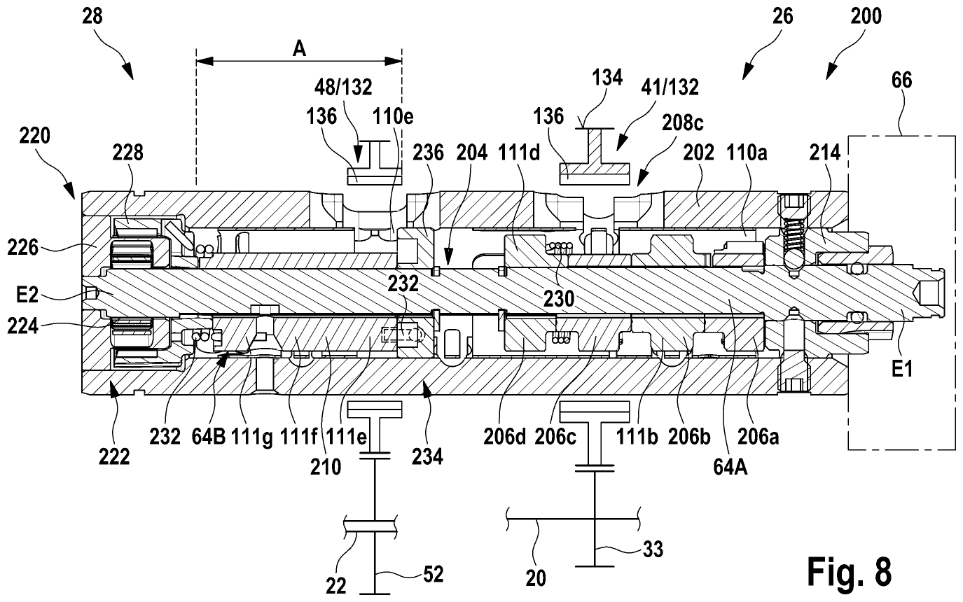

In FIG. 8, it can be seen that an idler gear 132 is assigned to the third cam body 206c, which can be, for example, the idler gear 41 for the third sub-transmission gear stage of the transmission unit 10 of FIG. 2. It is understood that corresponding idler gears 132 are assigned to the other cam bodies 206a, 206b, 206d.

The idler gear 132, which is shown in FIG. 8, has an internal toothing 136 into which a shifting pawl or a freewheel body, respectively, can engage in a form-fitting manner in one direction of rotation, which is pivotably mounted on the bearing portion 208c (not shown in FIG. 8). The idler gear 132, which is realized, for example, by the idler gear 41 of FIG. 2, is in engagement with a fixed gear 33, which is non-rotatably fixed on the input shaft 20.

The second camshaft 64B is formed by a cam body 210, which is designed as a hollow shaft. The cam body 210 is rotatably mounted in an axial portion A on the first camshaft 64A. The cam body 210 is assigned to the second sub-transmission 28. The second sub-transmission 28 includes three sub-transmission gear stages. Consequently, three cams 111e, 111f, 111g are formed on the cam body 210 (preferably integrally with the cam body 210), which are assigned to the respective idler gears of the second sub-transmission 28. In FIG. 8, it is schematically shown that an idler gear 132 is assigned to the cam 111e, which can be formed, for example, by an idler gear of the second sub-transmission, such as the idler gear 48 of FIG. 2. The idler gear 132 has an internal toothing 136, into which in turn a shifting pawl or a freewheel body 142 can engage in order to establish a form-fit between the idler gear 132 and the transmission shaft assembly 202 in a drive rotation direction. It is understood that corresponding idler gears are assigned to the other cams 111f, 111g. The idler gear 132 shown in FIG. 8, which can be realized, for example, by an idler gear 48 of FIG. 2, is in engagement with a fixed gear 52, which is fixed on an output shaft 22.

The present example includes the first sub-transmission 26 with four sub-transmission gear stages, and the second sub-transmission 28 with three sub-transmission gear stages. The two sub-transmissions 26, 28 are connected serially in the manner of a range-type transmission. Consequently, a total of 4×3=12 gear stages can be established with the sub-transmissions 26, 28.

The second sub-transmission 28 is arranged adjacent to a second end E2 of the first camshaft 64A.

The first camshaft 64A is rotatably mounted in the area of the first end E1 by means of a bearing portion 214 with respect to the transmission shaft assembly 202.

In the area of the second end E2, the first camshaft 64A and the second camshaft 64B are coupled to one another via a reversing transmission 220.

The reversing transmission is arranged coaxially to the axis of the first camshaft 64A and the axis of the transmission shaft assembly 202 and includes a planet gear set 222.

The planet gear set 222 has three members, which are coupled with the first camshaft 64A, the transmission shaft assembly 202, and the second camshaft 64B, respectively.

Preferably, a sun gear 224 of the planet gear set 222 is non-rotatably connected to the first camshaft 64A. A planet carrier 226 of the planet gear set 222 is preferably non-rotatably connected to the transmission shaft assembly 202. Preferably, the first camshaft 64A is indirectly mounted via the planet carrier 226 with respect to the transmission shaft assembly 202 in the area of the second end E2.

A ring gear 228 of the planet gear set 222 is preferably coupled with the second camshaft 64B in the form of the cam body 210.

While the cam bodies 206a, 206b, 206c are non-rotatably connected to the first camshaft 64A, the cam body 206d is rotatably mounted in a limited manner between two stops, not shown in more detail in FIG. 8, with respect to the first camshaft 64A. The cam body 206d is prestressed against one of the two stops by means of a functional spring 230.

Similarly, the cam body 210 (second camshaft 64B) is rotatably mounted in a limited manner between two stops, not shown in more detail in FIG. 8, with respect to the ring gear 228 of the second camshaft 64B. The cam body 210 is prestressed against one of the two stops by means of a functional spring 232.

Coaxially to the first camshaft 64A, a detent arrangement 234 is also provided between the first sub-transmission 26 and the second sub-transmission 28. The detent arrangement 234 includes a detent ring 236, which is arranged around the first camshaft 64A and is non-rotatably connected to the transmission shaft assembly 202.

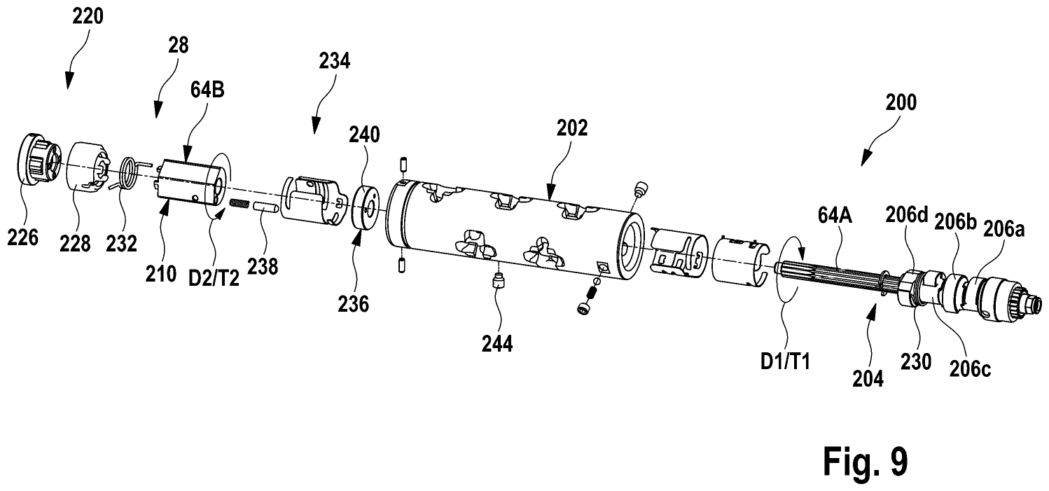

The detent ring 236 is in engagement with at least one detent body 238, which is axially displaceably mounted in the cam body 210, as can be seen in particular in FIG. 9. More precisely, the detent body 238 is prestressed by means of a spring, not shown in more detail, towards the detent ring 236, which includes a plurality of detent recesses, not shown in more detail.

In FIG. 9, however, a plurality of detent points 240 are schematically shown, which correspond to the respective detent recesses.

As can be seen in FIG. 9, a rotation of the first camshaft 64A in a first rotation direction D1 with a first torque T1 leads to a rotation of the second camshaft 64B in a second rotation direction D2 with a second torque T2.

The rotation directions D1, D2 are opposite to each other.

The planet gear set 222, which is connected between the first camshaft 64A and the second camshaft 64B, establishes a transmission ratio of 3:1 between them. A rotation of the first camshaft 64A by a certain rotation angle consequently leads to a rotation of the second camshaft in the opposite rotation direction by an angle that is one-third of the rotation angle of the first camshaft 64A.

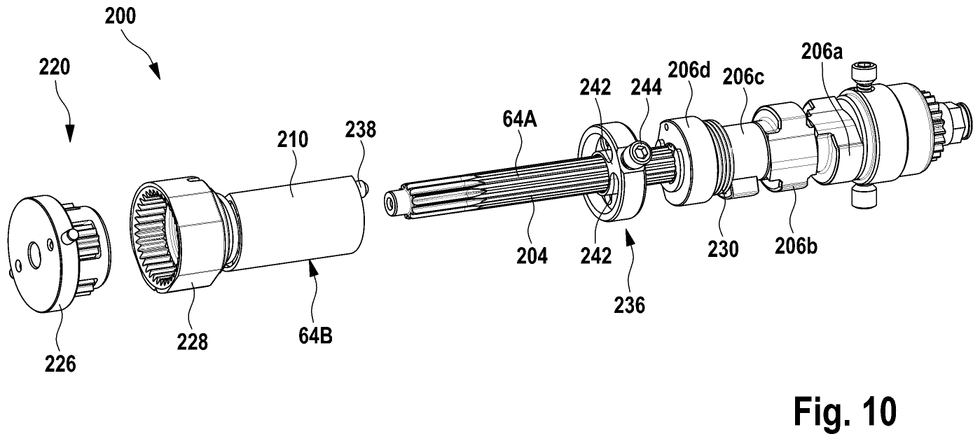

The first camshaft 64A is freely rotatable by 360°. The second camshaft 64B is rotatable by a maximum rotation angle that is smaller than 360° and is preferably established by rotation limiting stops 242, which are formed on the detent ring 236, as can be seen in FIG. 10. Preferably, the maximum rotation angle of the second camshaft 64B is limited to 300° with respect to the transmission shaft assembly 202.

In FIG. 10, it can also be seen that the detent ring 236 is fixed in the circumferential direction by means of a rotation-locking screw 244 with respect to the transmission shaft assembly 202.

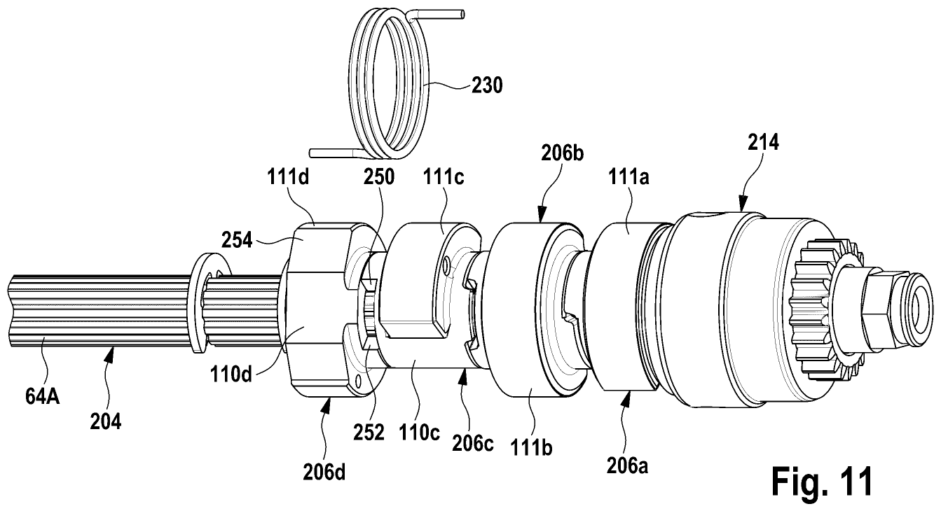

In FIG. 11, it can also be seen that on the cam body 206c for the third gear stage, which is adjacent to the cam body 206d, at least one functional stop 250 is formed. A not further specified axial projection of the cam body 206d forms at least one functional stop 252, whereby the maximum rotation angle between the first camshaft 64A (which is non-rotatably connected to the cam body 206c) and the cam body 206d is established by the functional stops 250, 252.

The cam body 206d is also prestressed against one of the functional stops 250, 252 by means of the functional spring 230.

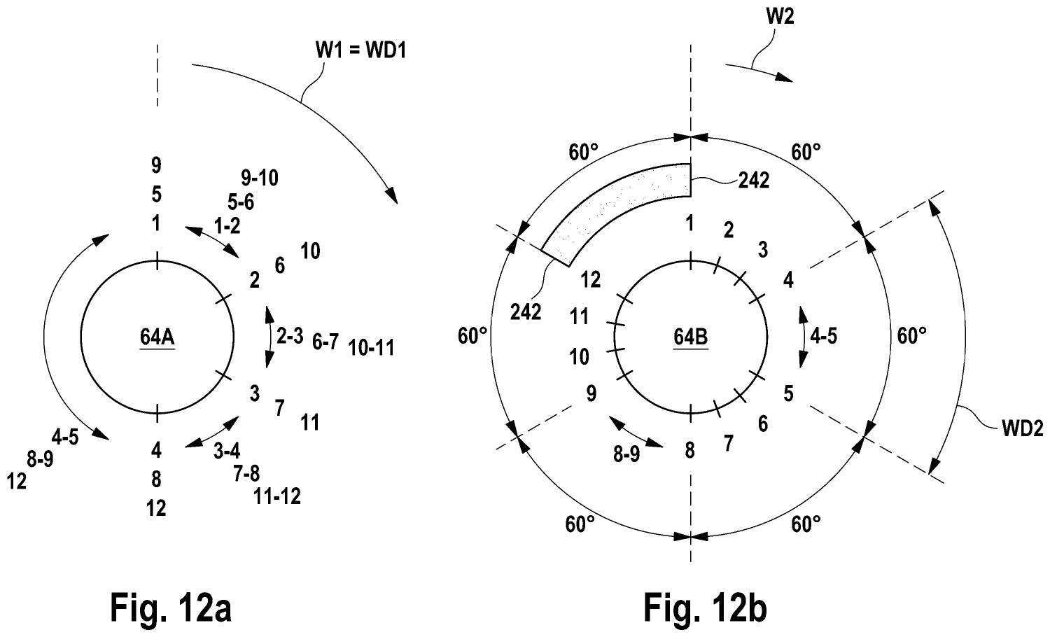

FIGS. 12a-b show schematically the first camshaft 64A and the second camshaft 64B and the assignment of the twelve gears realized herewith to individual rotation angles.

At 12 o'clock (0°), a basic position of the first camshaft 64A is shown in FIG. 12a, in which the first sub-transmission gear stage 1 of the first sub-transmission is engaged.

Correspondingly, the second camshaft 64B is shown in FIG. 12b, where a first sub-transmission gear stage 1 is also shown at 12 o'clock (0°).

At W1, it is shown that upon a rotation of the first camshaft 64A by a first rotation angle (=W1), the second camshaft 64B is rotated by a second rotation angle W2 due to the reversing transmission or due to the ratio-changing transmission, which is smaller than the first rotation angle W1. With a transmission ratio of 3:1, the second rotation angle W2 is, for example, 20°, when the first rotation angle W1 is 60°.

In FIG. 12b, the rotation limit of the second camshaft 64B to 300° is also shown, which is established by rotation limiting stops 242.

To engage gear stage 2, the first camshaft 64A is rotated by a first shift rotation angle WD1, which in the present case is equal to the first rotation angle W1, i.e., 60°. The second camshaft 64B is thereby co-rotated by 20°. In the first sub-transmission 64A, the gear shift 1-2 means a disengagement of the sub-transmission gear stage 1 (consequently a pivoting in of a form-locking body or shifting pawl 142) and an engagement of the second sub-transmission gear stage (consequently a pivoting out of the assigned freewheel body or shifting pawl 142 by means of the second cam body 206b). A further rotation of the first camshaft 64A by another 60° leads to the engagement of gear stage 3. A further rotation of the first camshaft 64A by another 60° leads to an engagement of gear stage 4. Hereby, the second camshaft 64B is rotated by 20° each time, so that gear stage 4 corresponds to a rotation of the second camshaft 64B by 60° (one-third of the angle of 180° by which the first camshaft 64A has been rotated).

To engage gear stage 5, the first camshaft 64A is now rotated by 180°, as shown in FIG. 12a. Hereby, the fourth sub-transmission gear stage is disengaged and the first sub-transmission gear stage of the first sub-transmission 26 is engaged again. Simultaneously, the first sub-transmission gear stage of the second sub-transmission 28 is disengaged and the second sub-transmission gear stage of the second sub-transmission 28 is engaged. Since the first camshaft 64A is rotated by 180° for this, the second camshaft 64B is rotated by 60°. This corresponds to a second shift rotation angle WD2 of 60° in FIG. 12b.

Starting from this position, a rotation of the first camshaft 64A in steps of 60° now occurs again, for engaging the forward gear stages 6, 7, 8, until the first camshaft 64A has rotated by 360°+180°=540°. The second camshaft 64B is then at 180° (540° divided by 3). Now, a double gear shift occurs again, in which the fourth sub-transmission gear stage of the first sub-transmission is disengaged and the first sub-transmission gear stage of the first sub-transmission 1 is engaged, and simultaneously the second sub-transmission gear stage of the second sub-transmission 28 is disengaged and the third sub-transmission gear stage of the second sub-transmission is engaged, in order to consequently shift from gear stage 8 of the overall transmission to gear stage 9. This occurs at the first sub-transmission 26 by a rotation of the camshaft 64A again by 180° (see FIG. 12a), and consequently by 60° in the second sub-transmission according to FIG. 12b. The first camshaft 64A has consequently rotated by 720° upon reaching gear stage 9 of the overall transmission, the second camshaft 64B by 240°.

Starting from here, a further rotation of the first camshaft 64A in 60° steps for engaging gear stages 10, 11, and 12 occurs up to a maximum rotation of the first camshaft 64A of 900° (corresponding to a maximum rotation of 300° of the second camshaft 64B, which is limited by the stop 242).

Downshifting occurs in a corresponding manner. An overview of the gear shifts with the respective rotation angles is shown below in Table 1.

TABLE 1

| | Camshaft rotation | Incremental | | Incremental | |
|---|---|---|---|---|---|
| | angle (TG1) at | rotation | | rotation | |
| | end of shifting | angle | TG1 | angle | TG2 |
| Gear shift | operation | W1 of TG1 | Gear | W2 of TG2 | Gear |
| 1->2 | 60° | 60° | 1->2 | 20° | 1 |
| 2->3 | 120° | 60° | 2->3 | 40° | 1 |
| 3->4 | 180° | 60° | 3->4 | 60° | 1 |
| 4->5 | 360° | 180° | 4->1 | 120° | 1->2 |
| 5->6 | 420° | 60° | 1->2 | 140° | 2 |
| 6->7 | 480° | 60° | 2->3 | 160° | 2 |
| 7->8 | 540° | 60° | 3->4 | 180° | 2 |
| 8->9 | 720° | 180° | 4->1 | 240° | 2->3 |
| 9->10 | 780° | 60° | 1->2 | 260° | 3 |
| 10->11 | 840° | 60° | 2->3 | 280° | 3 |
| 11->12 | 900° | 60° | 3->4 | 300° | 3 |

The above representation of the rotation angles W1, W2 was made for the sake of simpler representation without considering the rotatability of the cam body 206d and the cam body 210 (the second camshaft 64B).

Through this rotatability, however, a so-called asymmetrical camshaft timing can be realized, such that the shift rotation angle during downshifting differs from upshifting. In other words, the rotation angle-dependent angular positions at which shifting pawls or freewheel bodies pivot out or in are different for upshifting than for downshifting.

This can be advantageous for a first reason, because the shifting pawl exhibits a different engagement behavior during upshifting in many embodiments than during downshifting. During upshifting, it is principally the case that upon releasing the shifting pawl of the higher gear, the higher and faster gear immediately takes over the power transmission as soon as it comes into engagement with the shifting pawl of the higher gear, i.e., the target gear.

During downshifting, however, the target gear—i.e., the lower gear-only takes over the power transmission when the larger (faster) gear is disengaged. The point in time of the power transmission takeover of the target gear is therefore not dependent on the shifting pawl state of the target gear (as in upshifting), but dependent on the shifting pawl state of the source gear.

This different behavior leads to the risk during upshifting that only a partial engagement of the shifting pawl in the internal toothing of the associated gear wheel can occur: The shifting pawl is successively released by the rotation of the camshaft and takes over the power transmission as soon as it even partially comes into overlap with the internal toothing of the gear wheel. How quickly the shifting pawl is released is therefore dependent on the rotational speed of the camshaft. The probability of a full or only partial engagement of the shifting pawl in the internal toothing of the idler gear is therefore also dependent on the rotational speed of the camshaft.

During downshifting, this problem does not exist: the shifting pawl of the target gear (lower gear) is already in a state where it is fully released (freewheel state) and can therefore also fully engage in the internal toothing at the moment of releasing the shifting pawl of the higher gear. Only when the higher (faster) gear is brought out of engagement does the lower (slower) gear take over the power transmission. Until that point, the shifting pawl is in the freewheel state.

In other words, with the shifting arrangement disclosed herein, a jump actuation of the shifting pawl can be achieved despite a continuous camshaft rotation.

The necessity of such a mechanism is particularly given with a continuous and less jump-like rotation of the camshaft, as occurs, for example, with a shift actuator. The actuator has a fixed rotational speed, which ultimately determines the release speed of the shifting pawl.

The requirement thus becomes greater, the lower the rotational speed of the camshaft is. This is particularly the case with the use of the previously described reversing transmission, which in the specific case reduces the angular speed of the second camshaft 64B in the second sub-transmission 28 by a factor of 3.

In general, it is possible that such a pre-tensioning mechanism, realized by two stops, a functional spring 230 and a detent arrangement 234, is assigned to each gear or each shiftable idler gear of each sub-transmission, or any subset thereof.

A second advantageous reason for the asymmetrical camshaft timing is as follows. If, for example, cam bodies of different gears are not integrally formed with the camshaft (like the cam bodies 210 or 206d), play may occur between the cam bodies due to manufacturing tolerances.

A particularly large play arises, for example, in the present design, in which the camshaft 64B of sub-transmission 2 is connected via a reversing transmission 220 with the camshaft 64A of sub-transmission 1.

To solve this problem, a cam body 206a or 210 of the affected gear is also prestressed in one direction here.

In the present embodiment, for example, the cam body 206d of gear stage 4 is rotatably mounted on the camshaft 64A. The gear has stops 250, 252 in both rotation directions relative to the camshaft, which are designed such that a defined rotational play of the cam body 206d of gear 4 relative to the camshaft 64A results.

A torsion spring (leg spring) 230 ensures that the cam body 206d always rests against one of the two stops.

In the present embodiment, for example, the cam body 206d of sub-transmission gear stage 4 in sub-transmission 1 is rotatable between two stops 250, 252 relative to the camshaft 64A. When shifting from, for example, gear 4 to gear 5 of a 12-speed transmission, a shift is made in sub-transmission 1 from sub-transmission gear 4 to sub-transmission gear 1 and in sub-transmission 2 from sub-transmission gear 1 to sub-transmission gear 2. For a flawless function in both shifting directions, it is therefore necessary that the disengagement/engagement of sub-transmission gear stages 4 and 1 in sub-transmission 1 occurs as synchronously as possible with the engagement/disengagement of sub-transmission gear stages 1 and 2 in sub-transmission 2.

Overall, with the disclosed shifting arrangement, despite principled and manufacturing-related play between components, a nearly simultaneous pivoting in and out of the shifting pawls in both sub-transmissions and rotation directions can be achieved.

It is to be understood that the foregoing is a description of one or more preferred exemplary embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “for example,” “e.g.,” “for instance, “such as,” and “like,” and the verbs “comprising,” “having,” “including,” and their other verb forms, when used in conjunction with a listing of one or more components or other items, are each to be construed as open ended, meaning that the listing is not to be considered as excluding other, additional components or items. Other terms are to be construed using their broadest reasonable meaning unless they are used in a context that requires a different interpretation.

### REFERENCE NUMERALS

10 transmission unit
12 bicycle frame
14 transmission housing
16, 16′ crank arms
18 multi-speed transmission
20 input shaft
22 output shaft
24 chainring
26 first sub-transmission
28 second sub-transmission
30-35 drive gears
36 countershaft
38-43 driven gears/first idler gears
46 input shaft
48-50 drive gears/second idler gears
52-54 driven gears
56 spur-gear set EM/36
60 shifting arrangement
62 shaft
64 camshaft
66 speed-superposition transmission
68 transfer stage/first planetary transmission
70 control stage/second planetary transmission
72 sun gear (68)
74 planet gears (68)
76 planet carrier (68)
78 ring gear (68)
80 fixed reference point
82 sun gear (70)
84 planet gears (70)
86 ring gear (70)
88 traction disc
110 cam gap
111 cam
132 switchable idler gear
134 external toothing
136 internal toothing
138 sliding portions
140 engagement portions
142 freewheel body/shifting pawl
144 actuation portion
146 bearing portions
148 engagement portion
150 rotational axis
152 sliding portion
168 arrow
200 shifting arrangement
202 transmission shaft assembly/countershaft
204 camshaft assembly (64A, 64B)
206a/b/c/d cam body TG1
208a/b/c/d bearing portions for 142 TG1
110a-d cam gaps 206
111a-d cams 206
210 cam body TG2
110e/f/g cam gaps 210 (TG2)
111a/f/g cams 210 (TG2)
212e/f/g bearing portions for 142 TG2
110e-g cam gaps 210
111e-g cams 210
214 bearing portion
220 reversing transmission
222 planet gear set
224 sun gear
226 planet carrier
228 ring gear
230 functional spring for 206d
232 functional spring for 210
234 detent arrangement
236 detent ring
238 detent body
240 detent points
242 rotation limiting stops
244 rotation-locking screw
250 first functional stop
252 second functional stop
254 cam surface
Alpha, a flank angle 136
Beta, β engagement angle 148
E1 first axial end 204
E2 second axial end 204
A axial portion
D1 first rotation direction 64A
D2 second rotation direction 64B
W1 first rotation angle 64A
W2 second rotation angle 64B
T1 first torque 64A
T2 second torque 64B
WD1 first shift rotation angle 64A
WD2 second shift rotation angle 64B
EM electric motor

1. A vehicle transmission shifting arrangement, comprising: a transmission shaft assembly, on which a plurality of idler gears are rotatably mounted, which can be connected to the transmission shaft assembly via respective shifting devices,
wherein the shifting devices can be actuated by means of a camshaft assembly, which comprises a first camshaft, and
wherein the first camshaft and a second camshaft of the camshaft assembly are coupled to one another via a reversing transmission in such a way that a rotation of one of the camshafts in a first rotation direction leads to a rotation of the other camshaft in a second rotation direction, which is opposite to the first rotation direction.

2. The vehicle transmission shifting arrangement according to claim 1, wherein the transmission shaft assembly, (i) via which a drive force can be transmitted, (ii) on which a plurality of first idler gears of a first sub-transmission and a plurality of second idler gears of a second sub-transmission are rotatably mounted, which establish different gear stages, and (iii) which is formed, at least in a portion, as a hollow shaft,
wherein the camshaft assembly is rotatably mounted, at least in a portion, within the transmission shaft assembly and comprises the first camshaft assigned to the first idler gears and the second camshaft assigned to the second idler gears.

3. The vehicle transmission shifting arrangement according to claim 1, wherein the reversing transmission comprises a planet gear set, a first member of the planet gear set is coupled to the first camshaft, a second member of the planet gear set is coupled to the transmission shaft assembly, and a third member of the planet gear set is coupled to the second camshaft.

4. The vehicle transmission shifting arrangement according to claim 2, further comprising a speed-superposition transmission, via which the transmission shaft assembly and the camshaft assembly are coupled and which can be actuated in order to achieve, for shifting the gear stages, a relative rotation of the transmission shaft assembly and the camshaft assembly, wherein the speed-superposition transmission is coupled to the transmission shaft assembly and to one of the first and the second camshafts.

5. The vehicle transmission shifting arrangement according to claim 1, wherein a speed-superposition transmission is arranged at a first axial end of the camshaft assembly, and the reversing transmission is arranged at a second axial end of the camshaft assembly.

6. The vehicle transmission shifting arrangement according to claim 1, wherein the second camshaft is formed as a hollow shaft and is rotatably mounted on an axial portion of the first camshaft.

7. A vehicle transmission shifting arrangement, comprising: a transmission shaft assembly, on which a plurality of idler gears are rotatably mounted, which can be connected to the transmission shaft assembly via respective shifting devices,
wherein the shifting devices can be actuated by means of a camshaft assembly, which comprises a first camshaft, and
wherein the first camshaft and a second camshaft are coupled to one another via a ratio-changing transmission in such a way that a rotation of one of the camshafts by a first rotation angle leads to a rotation of the other camshaft by a second rotation angle, which differs from the first rotation angle.

8. The vehicle transmission shifting arrangement according to claim 7, wherein the ratio-changing transmission is designed such that the second rotation angle is smaller than the first rotation angle, and the ratio-changing transmission has a transmission ratio in a range of 2 to 4.

9. The vehicle transmission shifting arrangement according to claim 1, wherein the first camshaft is rotatable by 360° and the second camshaft is rotatable over an angular range that is smaller than 360°.

10. The vehicle transmission shifting arrangement according to claim 1, wherein each gear shift in a first sub-transmission is assigned a respective first shift rotation angle of the first camshaft, each gear shift in a second sub-transmission is assigned a respective second shift rotation angle of the second camshaft, and the first shift rotation angle of at least one gear shift in the first sub-transmission is equal to the second shift rotation angle of at least one gear shift in the second sub-transmission.

11. A vehicle transmission shifting arrangement, comprising: a transmission shaft assembly, on which a plurality of idler gears are rotatably mounted, which can be connected to the transmission shaft assembly via respective shifting devices,
wherein the shifting devices can be actuated by means of a camshaft assembly, which comprises a first camshaft,
wherein at least one shifting device is formed as a shifting pawl, which is radially pivotably mounted on the transmission shaft assembly and which can be actuated by means of a functional cam body of the camshaft assembly between a pivoted-in position and a gear position, and
wherein the functional cam body is formed as a cam body that is rotatably mounted in a limited manner between a first functional stop and a second functional stop.

12. The vehicle transmission shifting arrangement according to claim 11, wherein the functional cam body is prestressed against the first functional stop by means of a functional spring in such a way that it remains at the first functional stop during downshifts, and the functional cam body is rotated during upshifts against the action of the functional spring.

13. The vehicle transmission shifting arrangement according to claim 11, wherein the angle between the first functional stop and the second functional stop is selected such that it compensates at least a circumferential play that is present between the functional cam body and the assigned camshaft, and is adapted to a relative rotatability between the functional cam body and the assigned camshaft.

14. The vehicle transmission shifting arrangement according to claim 11, wherein the angle between the first functional stop and the second functional stop lies in a range of 5° to 20° or in a range of 50° to 80°.

15. The vehicle transmission shifting arrangement according to claim 11, wherein the angle between the first functional stop and the second functional stop is selected such that engaging of a target gear stage is enabled in a manner independent of a shifting contour.

16. The vehicle transmission shifting arrangement according to claim 11, wherein the functional cam body is assigned to a highest gear stage of a first sub-transmission.

17. The vehicle transmission shifting arrangement according to claim 1, wherein the second camshaft is rotatably mounted with respect to the first camshaft in a limited manner between a first coupling stop and a second coupling stop and is prestressed against the first coupling stop by means of a functional spring, wherein the second camshaft is held at a plurality of detent points with respect to the transmission shaft assembly by means of a detent arrangement.

18. A vehicle transmission unit, comprising: a shifting arrangement which comprises a transmission shaft assembly, on which a plurality of idler gears are rotatably mounted, which can be connected to the transmission shaft assembly via respective shifting devices,
wherein the shifting devices can be actuated by means of a camshaft assembly, which comprises a first camshaft, and
wherein the first camshaft and a second camshaft of the camshaft assembly are coupled to one another via a reversing transmission in such a way that a rotation of one of the camshafts in a first rotation direction leads to a rotation of the other camshaft in a second rotation direction, which is opposite to the first rotation direction.

19. A method for performing gear shifts by means of a vehicle transmission shifting arrangement which comprises a transmission shaft assembly, on which a plurality of idler gears are rotatably mounted, which can be connected to the transmission shaft assembly via respective shifting devices,
wherein the shifting devices can be actuated by means of a camshaft assembly, which comprises a first camshaft,
wherein the first camshaft and a second camshaft of the camshaft assembly are coupled to one another via a reversing transmission in such a way that a rotation of one of the camshafts in a first rotation direction leads to a rotation of the other camshaft in a second rotation direction, which is opposite to the first rotation direction,
the method comprising the step of: rotating the camshaft assembly by a shift rotation angle to disengage a source gear stage and to engage a target gear stage.
